(19) United States
(12) Patent Application Publication
(10) Pub. No.: US 2009/0044214 A1
(43) Pub. Date: Feb. 12, 2009

(54) Optical Disk Drive

(76) Inventor: Hung-Chi Teng, Taichung City (TW)

Correspondence Address: HDSL, P.O. BOX 220746, CHANTILLY, VA, 20153-0746, US

(21) Appl. No.: 11/836,769

(22) Filed: Aug. 9, 2007

(51) Int. Cl. G11B 17/028

(52) U.S. Cl. 720/706

(57) ABSTRACT

An optical disk drive has a horizontal adjustment mechanism for a spindle motor formed thereon. The optical disk drive includes a horizontal adjustment mechanism, disposed between a base plate on a traverse module and a securing plate on the spindle motor, to regulate an inclination angle of an optical disc on the spindle motor relative to a laser pickup head.

### BACKGROUND OF THE INVENTION

1. Field of the Invention

The present invention relates to optical disk drives, and more particularly to an optical disk drive with a horizontal adjustment mechanism for a spindle motor thereon.

2. Description of Related Art

Presently, in an optical disk drive, a perfect angle between a light beam emitted from a laser pickup head and an optical disc may be 90 degrees. An acceptable error range is between zero degrees and approximate 10 degrees. During assembly of the optical disk drive, the actual error range of the angle between a light beam emitted from a laser pickup head and an optical disc usually goes beyond the acceptable error range. Therefore, an inclination angle of the laser pickup head relative to the optical disc must be properly regulated. However, the laser pickup head is generally mounted to the sliding apparatus having a pair of sliding rails thereon. When the actual error range of the angle between the light beam emitted from the laser pickup head and the optical disc goes beyond the acceptable error range, conventionally, the sliding rails should be regulated in a horizontal direction. Thus, a plurality of components of the optical disk drive is often regulated, which causes time-consuming and laborious. As a result, it is a disadvantage to save production time and reduce manufacturing cost.

On this account, the inventors have deeply analyzed and researched the above-mentioned problems in conventional optical disk drives. Meanwhile, the solution of the problems has been seeking actively by the inventors. After a long-term research and development, a new optical disk drive in accordance with the present invention has been designed successfully.

### SUMMARY OF THE INVENTION

What is needed, therefore, is to provide an optical disk drive with a horizontal adjustment mechanism for a spindle motor thereon, which causes to save time and reduce production cost due to utilization of the horizontal adjustment mechanism.

An object and effect of the present invention is carried out through the following technology means. The optical disk drive of the present invention includes a horizontal adjustment mechanism, disposed between a base plate on a traverse module and a securing plate on the spindle motor, to regulate an inclination angle of an optical disc on a spindle motor relative to a laser pickup head.

Conventionally, the laser pickup head is regulated in a horizontal direction relative to the spindle motor. Comparing with the conventional technology, the spindle motor in the present invention is regulated in a horizontal direction relative to the laser pickup head. Thus, the structure of the optical disk drive is simplified and adjustment time is reduced. As a result, mass production is speeded up and manufacturing cost is cut down.

Other advantages and novel features will be drawn from the following detailed description of preferred embodiment with the attached drawings, in which:

### BRIEF DESCRIPTION OF THE DRAWINGS

FIG. 1 is an enlarged, isometric view of an optical disk drive in accordance with a preferred embodiment of the present invention including a base plate, a pair of guide rails, a spindle motor, a horizontal adjustment mechanism, and a laser pickup head;

FIG. 2 is a front view of FIG. 1;

FIG. 3 is a top view of FIG. 2;

FIG. 4 is a side view of FIG. 2;

FIG. 5 is another enlarged, isometric view of the optical disk drive in accordance with a preferred embodiment of the present invention;

FIG. 6 is a partially exploded, isometric view of the optical disk drive in accordance with a preferred embodiment of the present invention.

### DETAILED DESCRIPTION OF THE INVENTION

According to principles of the present invention, a horizontal adjustment mechanism, disposed between a base plate on a traverse module and a securing plate on the spindle motor, is provided to regulate an inclination angle of an optical disc on the spindle motor relative to a laser pickup head.

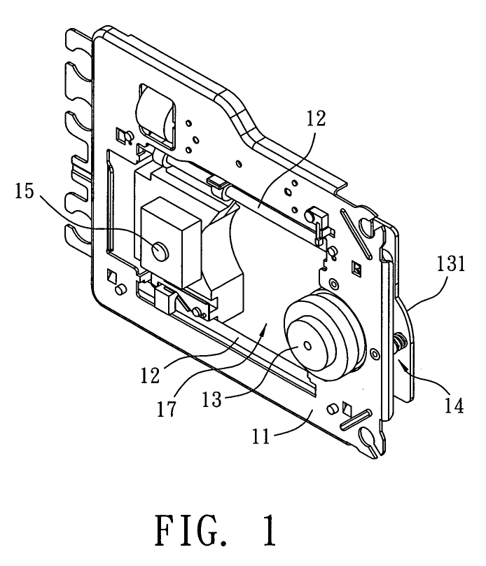

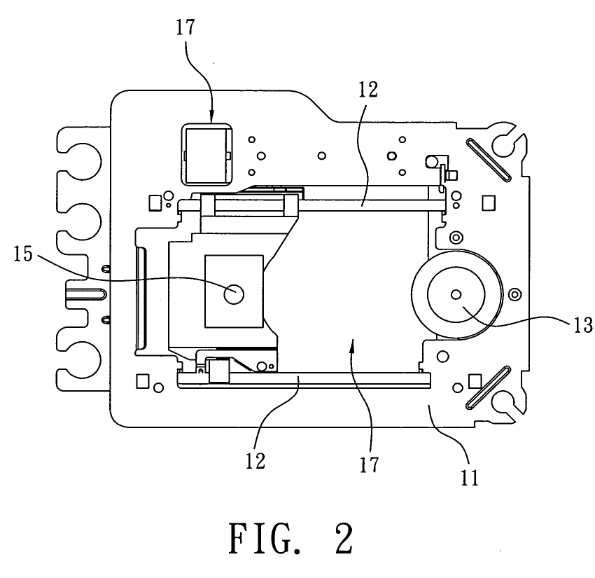

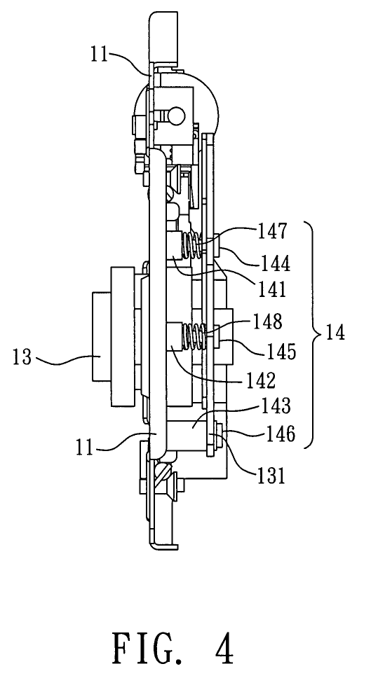

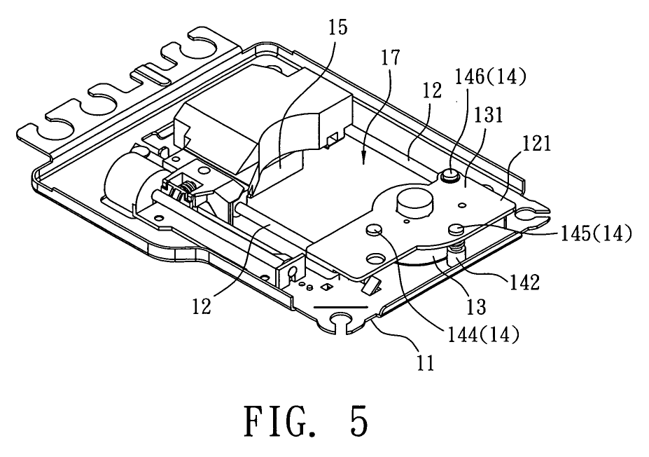

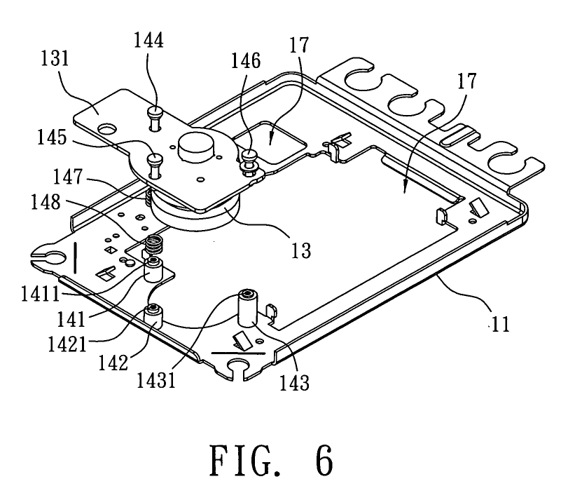

Referring to FIGS. 1 to 6, an optical disk drive in accordance with a preferred embodiment of the present invention mainly includes a base plate 11, a pair of guide rails 12, a spindle motor 13, a horizontal adjustment mechanism 14, and a laser pickup head 15. The laser pickup head 15 is slidably mounted on the guide rails 12. The spindle motor 13 is used to drive an optical disc 16 thereon. The spindle motor 13 is formed to have a securing plate 131 thereon. The horizontal adjustment mechanism 14 is disposed between the base plate 11 on a traverse module and the securing plate 131 of the spindle motor 13 to regulate an inclination angle of the optical disc 16 on the spindle motor 13 relative to the laser pickup head 15. In the preferred embodiment, conventionally, the base plate 11 defines a plurality of different openings 17 corresponding to other components therein.

In the preferred embodiment of the present invention, the horizontal adjustment mechanism includes a first post 141, a second post 142, a third post 143, a first adjustable thread shaft 144, a second adjustable thread shaft 145, and a locking thread shaft 146. The first, second, and third posts 141, 142, 143 extend vertically from the base plate 11 and are arranged in triangle form. The first, second, and third posts 141, 142, 143 respectively define an inner screw hole 1411, 1421, 1431. A height of the third post 143 is greater than a height of the first and second posts 141, 142. The locking thread shaft 146 extends through the securing plate 131 to engage with the third post 143, thereby firmly mounting the securing plate 131 to the third post 143. The first adjustable thread shaft 144 extends through the securing plate 131 to engage with the first post 141, and a first spring 147 is placed around the first adjustable thread shaft 144 and located between the securing plate 131 and the first post 141. The second adjustable thread shaft 145 extends through the securing plate 131 to engage with the second post 142, and a second spring 148 is placed around the second adjustable thread shaft 145 and located between the securing plate 131 and the first post 141.

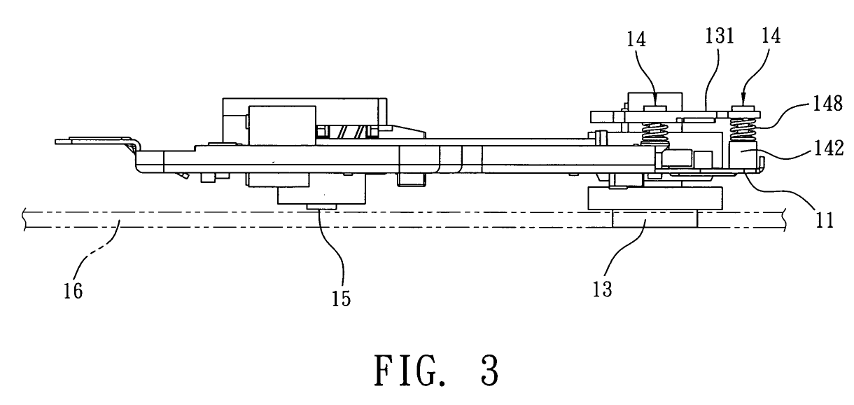

FIGS. 1 to 5 show different views in different positions after assembly of the optical disk drive. In operation, especially referring to FIG. 3, when the locking thread shaft 146 extends through the securing plate 131 to engage with the third post 143, the securing plate 131 does not touch the first and second posts 141, 142. The first spring 147 is located between the securing plate 131 and the first post 141 to resist against the securing plate 131 and the first post 141. Similarly, the second spring 148 is located between the securing plate 131 and the second post 142 to resist against the securing plate 131 and the second post 142. Therefore, the level of the securing plate 131 is regulated by adjustment of the first and second adjustable thread shafts 144, 145, and the third post 143 serves as a support point considered as a reference point.

In the preferred embodiment of the present invention, only adjusting the first and second adjustable thread shafts 144, 145 can easily and quickly regulate the inclination angle of the laser pickup head 15 relative to the optical disc 16 on the spindle motor 13, because the third post 143 serves as the support point considered as the reference point. Thus, the adjustment mechanism may be simplified to thereby expedite mass production and to cut down the manufacturing cost. Accordingly, manufacturer has the advantage of strong competition.

While the present invention has been illustrated by the description of preferred embodiments thereof, and while the preferred embodiments have been described in considerable detail, it is not intended to restrict or in any way limit the scope of the appended claims to such details. Additional advantages and modifications within the spirit and scope of the present invention will readily appear to those skilled in the art. Therefore, the present invention is not limited to the specific details and illustrative examples shown and described.

What is claimed is:

1. An optical disk drive comprising:
a laser pickup head;
a pair of guide rails, the laser pickup head slidably mounted on the guide rails;
a spindle motor for driving an optical disc thereon, the spindle motor having a securing plate;
a base plate configured for mounting the laser pickup head, the pair of guide rails, and the spindle motor thereon; and
a horizontal adjustment mechanism disposed between the base plate and the securing plate for regulating an inclination angle of the optical disc on the spindle motor relative to the laser pickup head.

2. The optical disk drive as described in claim 1, wherein the horizontal adjustment mechanism comprises:
a first post disposed on the base plate, the first post defining an inner thread hole;
a second post disposed on the base plate, the second post defining an inner thread hole;
a third post disposed on the base plate, the third post defining an inner thread hole; wherein a height of the third post is greater than a height of the first and second posts, the first, second, and third posts are arranged in triangle form on the base plate;
a locking thread shaft for securely mounting the securing plate on the third post;
a first adjustable thread shaft extending through the securing plate to engage with the first post, wherein a first spring is placed around the first adjustable thread shaft and located between the securing plate and the first post;
a second adjustable thread shaft extending through the securing plate to engage with the second post, wherein a second spring is placed around the second adjustable thread shaft and located between the securing plate and the second post.
